(19) United States
(12) Patent Application Publication
(10) Pub. No.: US 2005/0262314 A1
(43) Pub. Date: Nov. 24, 2005

(54) System and method for circular buffer

(76) Inventor: Yong S. Oh, Shrewsbury, MA (US)

Correspondence Address: MCANDREWS HELD & MALLOY, LTD, 500 WEST MADISON STREET, SUITE 3400, CHICAGO, IL, 60661, US

(21) Appl. No.: 11/000,676

(22) Filed: Dec. 1, 2004

Related U.S. Application Data
(60) Provisional application No. 60/573,096, filed on May 21, 2004.

(51) Int. Cl. G06F 12/00

(52) U.S. Cl. 711/154

(57) ABSTRACT

A system and method that determine whether a circular buffer is empty or full. The method may utilize two pointers, one to write data to the buffer, and one to read data from the buffer. The pointers may be initialized to point to the first location of the buffer. Each pointer may have an associated bit, where a bit may get toggled when the associated pointer wraps around the circular buffer and returns to the first location. Initially, the two bits may be equal. When the two pointers are equal, the two associated bits may be examined. If they are equal, that may indicate the buffer is empty, and the pointer that reads data should not pass the pointer that writes data. If the two bits are not equal, that may indicate the buffer is full, and the pointer that writes data should not pass the pointer that reads data.

### RELATED APPLICATIONS

This patent application makes reference to, claims priority to and claims benefit from U.S. Provisional Patent Application Serial No. 60/573,096, entitled “System and Method for Circular Buffer,” filed on May 21, 2004, the complete subject matter of which is hereby incorporated herein by reference, in its entirety.

This application is related to the following applications, each of which is incorporated herein by reference in its entirety for all purposes:

U.S. patent application Ser. No. ______ (Attorney Docket No. 15747US02) filed ______, 2004;

U.S. patent application Ser. No. ______ (Attorney Docket No. 15748US02) filed Oct. 13, 2004;

U.S. patent application Ser. No. ______ (Attorney Docket No. 15749US02) filed Nov. 10, 2004;

U.S. patent application Ser. No. ______ (Attorney Docket No. 15750US02) filed ______, 2004;

U.S. patent application Ser. No. ______ (Attorney Docket No. 15751US02) filed Nov. 10, 2004;

U.S. patent application Ser. No. ______ (Attorney Docket No. 15756US02) filed Oct. 13, 2004;

U.S. patent application Ser. No. ______ (Attorney Docket No. 15757US02) filed Oct. 25, 2004;

U.S. patent application Ser. No. ______ (Attorney Docket No. 15759US02) filed Oct. 27, 2004;

U.S. patent application Ser. No. ______ (Attorney Docket No. 15760US02) filed Oct. 27, 2004;

U.S. patent application Ser. No. ______ (Attorney Docket No. 15761US02) filed Oct. 21, 2004;

U.S. patent application Ser. No. ______ (Attorney Docket No. 15762US02) filed Oct. 13, 2004;

U.S. patent application Ser. No. ______ (Attorney Docket No. 15763US02) filed ______, 2004;

U.S. patent application Ser. No. ______ (Attorney Docket No. 15792US01) filed ______, 2004; and

U.S. patent application Ser. No. ______ (Attorney Docket No. 15810US02) filed ______, 2004.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Many systems such as, for example, audio or video systems utilize processors associated with memory and memory units. Processors often write to and read from memory when executing applications. Reading and writing may involve using pointers that point to buffers in the memory, to a location where the process writes to or reads from. Some buffers may be circular, where the buffer has, for example, 1000 locations (0-999). When a pointer gets to the last location in the buffer, i.e. location 999, it wraps around and points to the first location in the buffer, i.e. location 0. Usually, the READ and WRITE functions may not occur simultaneously, and often the pointers end up pointing to the same location in a circular buffer. When a READ pointer and a WRITE pointer are pointing to the same location, it may be an indication the buffer is either full or empty.

Traditionally, software has been used to determine whether a circular buffer is full or empty, which may require using an interrupt. In certain systems that run real-time applications, it may be too costly to have interrupts, which may cause delays in the system.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the present invention may be seen in a system and method that determine whether a section of storage in memory is empty or full. The method may comprise initializing two pointers to point to a starting location of the section of storage; initializing two bits associated with the two pointers; determining when the two pointers are pointing to the same location within the buffer; and comparing the values of the two bits to determine whether the section of storage is empty or full. The section of the storage may be a circular buffer, and each of the two bits may get toggled when the pointer associated with the bit returns to the starting location.

The method may further comprise utilizing one of the two pointers to read data from the section of storage, and utilizing the other one of the two pointers to write data to the section of storage.

In an embodiment of the present invention, the two bits may be initialized to equal values. In such an embodiment, it may be determined that the section of storage is empty when the two bits are equal, and full when the two bits are not equal.

In an embodiment of the present invention, one of the two pointers may be a pointer that reads data from the section of storage, and the other one of the two pointers may be a pointer that writes data to the section of storage. The method may further comprise preventing the pointer that reads data from passing the pointer that writes data when the section of storage is empty, and preventing the pointer that writes data from passing the pointer that reads data when the section of storage is full.

The system comprises at least one processor capable of performing the method that determines whether a section of storage in memory is empty or full.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 illustrates a block diagram of an exemplary circular buffer, in accordance with an embodiment of the present invention.

FIG. 2 illustrates a flow diagram of an exemplary process that determines whether a circular buffer is full or empty when a read pointer and a write pointer point to the same address, in accordance with an embodiment of the present invention.

FIG. 3 illustrates an exemplary computer system, in accordance with an embodiment of the present invention.

FIG. 4 illustrates a block diagram of an exemplary circuit for decoding video data, in accordance with an embodiment of the present invention.

### DETAILED DESCRIPTION OF THE INVENTION

Aspects of the present invention generally relate to determining conditions of memory locations such as, for example, buffers. More specifically, aspects of the present invention relate to using simplified solutions in determining whether a circular buffer is full or empty.

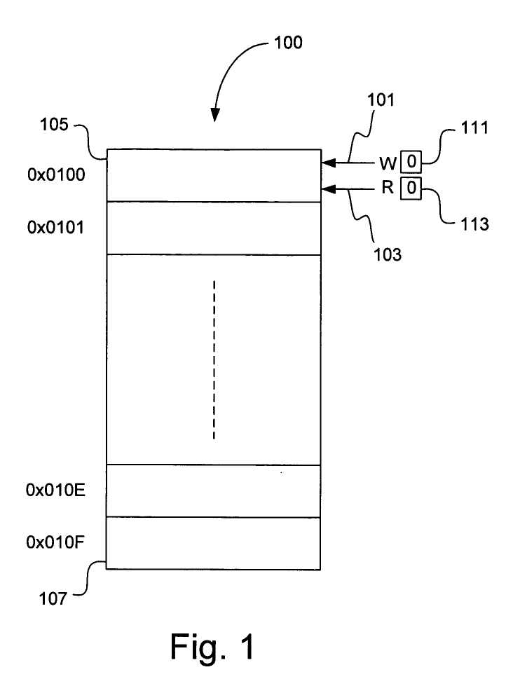

FIG. 1 illustrates a block diagram of an exemplary circular buffer 100, in accordance with an embodiment of the present invention. The circular buffer 100 may occupy a section of memory comprising, for example, 16 memory locations, starting at a first address 105, for example, 0×0100 and ending at a last address 107, for example, 0×010F.

At initialization, the circular buffer 100 may be empty, and a WRITE pointer 101 and a READ pointer 103 may point to the first address 105. The WRITE pointer 101 may be associated with a wrapping bit 111. The READ pointer 103 may be associated with a wrapping bit 113. The wrapping bits 111 and 113 may be reset to the same value such as, for example, zero upon initialization. At initialization, as a result, both the WRITE pointer 101 and the READ pointer 103 may have the same value including their respective wrapping bits 111 and 113.

When processing begins, data may be written to and read from the circular buffer 100. The WRITE pointer 101 and the READ pointer 103 may increment as necessitated by the processing. When either pointer gets to the end of the circular buffer 100, i.e., the last address 107, the pointer may wrap around and go back to the beginning of the circular buffer 100 at the first address 105.

In an embodiment of the present invention, following initialization, the READ pointer 103 may not be able to begin reading from the circular buffet 100 until values start getting written into the buffer.

When a pointer such as, for example, the WRITE pointer 101 or the READ pointer 103 wraps around to the beginning of the circular buffer 100, the associated wrapping bit may get toggled. For example, the WRITE pointer 101 may wrap around the circular buffer 100 and go from the last address 107 to the first address 105, and the wrapping bit 111 may get toggled from 0 to 1 or 1 to 0 depending on its value.

In an embodiment of the present invention, the WRITE pointer 101 and the READ pointer 103 may end up pointing to the same location. In such a case, the circular buffer 100 may be either full or empty. To determine whether the circular buffer 100 is full or empty the wrapping bits 111 and 113 may be examined. When the wrapping bits 111 and 113 have the same value that may indicate that the circular buffer 100 may be empty or may not contain valid data. When the wrapping bits 111 and 113 have different values that may indicate that the circular buffer 100 may be full and data may need to be read before writing more into it.

In an alternative embodiment of the present invention, upon initialization the wrapping bits 111 and 113 may be set to different values, where one may be set to 1 and the other one may be set to 0. In such an embodiment, when the wrapping bits 111 and 113 have the same value that may indicate that the circular buffer 100 may be full. When the wrapping bits 111 and 113 have different values that may indicate that the circular buffer 100 may be empty.

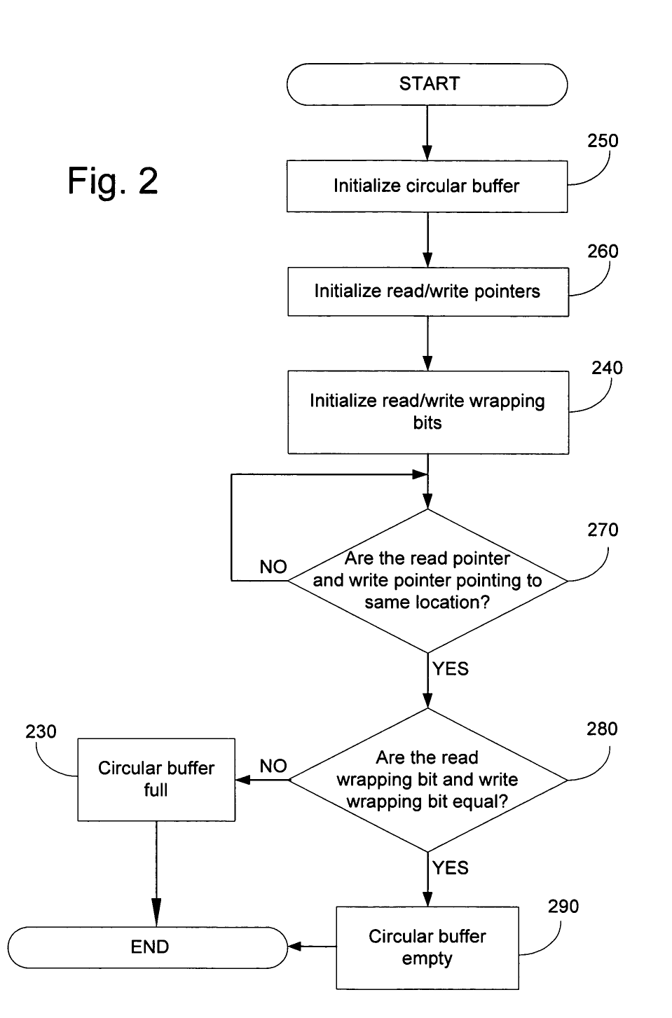

FIG. 2 illustrates a flow diagram of an exemplary process that determines whether a circular buffer is full or empty when a READ pointer and a WRITE pointer point to the same address, in accordance with an embodiment of the present invention. At 250 a circular buffer such as, for example, the circular buffer 100 of FIG. 1 may be initialized. The circular buffer may have a first address and a last address, and the buffer may not contain any data. A WRITE pointer and a READ pointer may be initialized to point to the first address of the circular buffer at 260. The wrapping bits associated with the READ and WRITE pointers may be then initialized at 240, for example, and they may be set to be equal. The READ pointer and WRITE pointer may then be examined at 270 to determine whether they may be pointing to the same location in the circular buffer. If the READ and WRITE pointers are not pointing to the same location, the condition may be checked until they are. When the READ and WRITE pointer are pointing to the same location in the circular buffer, the wrapping bits associated with the READ and WRITE pointers may be checked at 280 to determine whether they are equal or not. If the wrapping bits are equal then a decision may be made that the circular buffer is empty, and it may be determined at 290 that data may need to be written to the buffer before new data may be read from the buffer. If the wrapping bits are not equal then a decision may be made that the circular buffer may be full, and it may be determined at 230 that data may need to be read from the buffer before new data may be written to the buffer. The same process may be repeated starting at 270 to continuously make sure that the READ pointer does not pass the WRITE pointer when the buffer is empty, and the WRITE pointer does not pass the READ pointer when the buffer is full.

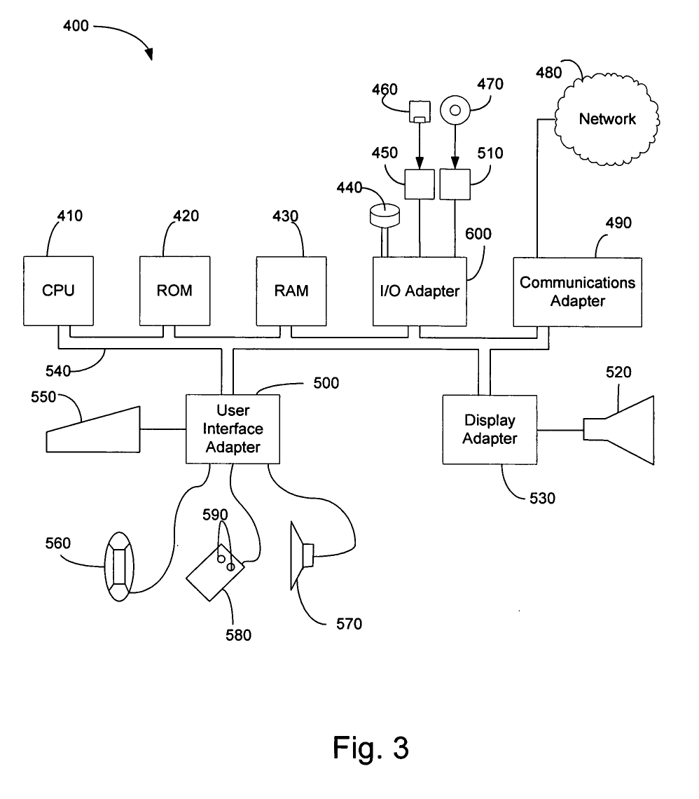

FIG. 3 illustrates an exemplary computer system 400, in accordance with an embodiment of the present invention. A central processing unit (CPU) 410 may be interconnected via a system bus 540 to a random access memory (RAM) 430, a read only memory (ROM) 420, an input/output (I/O) adapter 600, a user interface adapter 500, a communications adapter 490, and a display adapter 530. The I/O adapter 600 may connect to the bus 540 peripheral devices such as hard disc drives 440, floppy disc drives 450 for reading removable floppy discs 460, and optical disc drives 510 for reading removable optical discs 470 (such as a compact disc or a digital versatile disc). The user interface adapter 500 may connect to the bus 540 devices such as a keyboard 550, a mouse 580 having a plurality of buttons 590, a speaker 570, a microphone 560, and/or other user interface devices such as a touch screen device (not shown). The communications adapter 490 may connect the computer system to a data processing network 480. The display adapter 530 may connect a monitor 520 to the bus 540.

An embodiment of the present invention may be implemented as sets of instructions resident in the RAM 430 of one or more computer systems 400 configured generally as described in FIG. 2. Until required by the computer system 400, the sets of instructions may be stored in another computer readable memory, for example in a hard disc drive 440, or in removable memory such as an optical disc 470 for eventual use in an optical disc drive 510, or in a floppy disc 460 for eventual use in a floppy disc drive 450. The physical storage of the sets of instructions may physically change the medium upon which it is stored electrically, magnetically, or chemically so that the medium carries computer readable information.

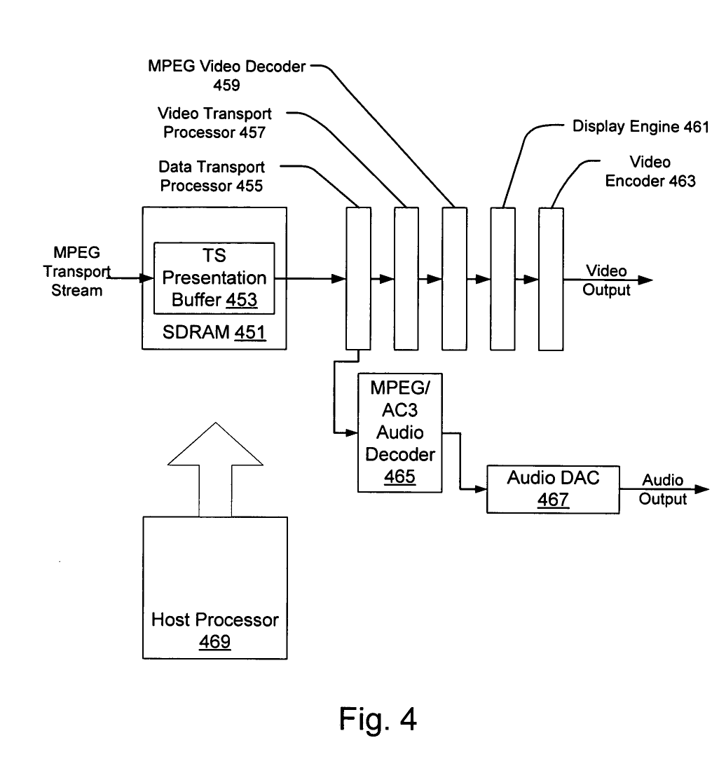

FIG. 4 illustrates a block diagram of an exemplary circuit for decoding video data, in accordance with an embodiment of the present invention. Video data may be received and stored in a presentation buffer 453 within a Synchronous Dynamic Random Access Memory (SDRAM) 451.

The data output from the presentation buffer 453 may then be passed to a data transport processor 455. The data transport processor 455 may de-multiplex the transport stream into packetized elementary stream constituents, and may pass the audio transport stream to an audio decoder 465 and the video transport stream to a video transport processor 457 and then to a MPEG video decoder 459. The audio data may then be sent to the output blocks, and the video may be sent to a display engine 461.

The display engine 461 may scale the video picture, render the graphics, and construct the complete display. Once the display is ready to be presented, it may be passed to a video encoder 463 where it may be converted to analog video using an internal digital to analog converter (DAC). The digital audio may be converted to analog in an audio digital to analog converter (DAC) 467. The display engine 461 may then display the decoded images onto a display device, e.g. monitor, television screen, etc., at the proper time and at the correct spatial and temporal resolution.

A conventional system may utilize one processor to implement the decoder 459 and display engine 461. The decoding and display processes may be implemented as firmware in SRAM executed by a processor. The decoding process and many parts of the displaying process may be very hardware-dependent. Additionally, the decoding process may be computationally intense. In an embodiment of the present invention, a host processor 469 may oversee the processes associated with the different parts of the decoder.

At least portions of the video and/or audio decoding may utilize buffers during the decoding process and for outputting the decoded video and/or audio. Buffers may be also used in different portions of memory such as, for example, the SDRAM 451. The buffers used in the video and/or audio decoder may be circular, and may utilize an embodiment of the present invention to ensure that erroneous video or audio not be written to or read from the utilized buffers.

The present invention may be realized in hardware, software, firmware and/or a combination thereof. The present invention may be realized in a centralized fashion in at least one computer system, or in a distributed fashion where different elements are spread across several interconnected computer systems. Any kind of computer system or other apparatus adapted for carrying out the methods described herein may be suitable. A typical combination of hardware and software may be a general-purpose computer system with a computer program that, when being loaded and executed, controls the computer system to carry out the methods described herein.

The present invention may also be embedded in a computer program product comprising all of the features enabling implementation of the methods described herein which when loaded in a computer system is adapted to carry out these methods. Computer program in the present context means any expression, in any language, code or notation, of a set of instructions intended to cause a system having information processing capability to perform a particular function either directly or after either or both of the following: a) conversion to another language, code or notation; and b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method that determines whether a section of storage in memory is empty or full, the method comprising:
initializing two pointers to point to a starting location of the section of storage;
initializing two bits associated with the two pointers;
determining when the two pointers are pointing to the same location within the buffer; and
comparing the values of the two bits to determine whether the section of storage is empty or full.

2. The method according to claim 1 wherein the section of storage is a circular buffer.

3. The method according to claim 2 wherein each of the two bits gets toggled when the pointer associated with the bit returns to the starting location.

4. The method according to claim 1 further comprising:
utilizing one of the two pointers to read data from the section of storage; and
utilizing the other one of the two pointers to write data to the section of storage.

5. The method according to claim 1 wherein the two bits are initialized to equal values.

6. The method according to claim 5 further comprising determining that the section of storage is empty when the two bits are equal.

7. The method according to claim 5 further comprising determining that the section of storage is full when the two bits are not equal.

8. The method according to claim 1 wherein the two bits are initialized to different values.

9. The method according to claim 8 further comprising determining that the section of storage is empty when the two bits are not equal.

10. The method according to claim 8 further comprising determining that the section of storage is full when the two bits are equal.

11. The method according to claim 1 wherein one of the two pointers is a pointer that reads data from the section of storage, and the other one of the two pointers is a pointer that writes data to the section of storage.

12. The method according to claim 11 further comprising:
preventing the pointer that reads data from passing the pointer that writes data when the section of storage is empty; and
preventing the pointer that writes data from passing the pointer that reads data when the section of storage is full.

13. A system that determines whether a section of storage in memory is empty or full, the system comprising:
at least one processor capable of initializing two pointers to point to a starting location of the section of storage;
the at least one processor capable of initializing two bits associated with the two pointers;
the at least one processor capable of determining when the two pointers are pointing to the same location within the buffer; and
the at least one processor capable of comparing the values of the two bits to determine whether the section of storage is empty or full.

14. The system according to claim 13 wherein the section of storage is a circular buffer.

15. The system according to claim 14 wherein each of the two bits gets toggled when the pointer associated with the bit returns to the starting location.

16. The system according to claim 13 further comprising:
the at least one processor capable of utilizing one of the two pointers to read data from the section of storage; and
the at least one processor capable of utilizing the other one of the two pointers to write data to the section of storage.

17. The system according to claim 13 wherein the two bits are initialized to equal values.

18. The system according to claim 17 further comprising the at least one processor capable of determining that the section of storage is empty when the two bits are equal.

19. The system according to claim 17 further comprising the at least one processor capable of determining that the section of storage is full when the two bits are not equal.

20. The system according to claim 13 wherein the two bits are initialized to different values.

21. The system according to claim 20 further comprising the at least one processor capable of determining that the section of storage is empty when the two bits are not equal.

22. The system according to claim 20 further comprising the at least one processor capable of determining that the section of storage is full when the two bits are equal.

23. The system according to claim 13 wherein one of the two pointers is a pointer that reads data from the section of storage, and the other one of the two pointers is a pointer that writes data to the section of storage.

24. The system according to claim 23 further comprising:
the at least one processor capable of preventing the pointer that reads data from passing the pointer that writes data when the section of storage is empty; and
the at least one processor capable of preventing the pointer that writes data from passing the pointer that reads data when the section of storage is full.
